(19) United States
(12) Patent Application Publication
(10) Pub. No.: US 2013/0179223 A1
(43) Pub. Date: Jul. 11, 2013

(54) METHOD AND ARRANGEMENT FOR SEGMENTATION OF TELECOMMUNICATION CUSTOMERS

(71) Applicants: Saravanan Mohan, Chennai (IN); Kasarapu Parthan, Chennai (IN); Prasad Garigipati, Chennai (IN)

(72) Inventors: Saravanan Mohan, Chennai (IN); Kasarapu Parthan, Chennai (IN); Prasad Garigipati, Chennai (IN)

(73) Assignee: TELEFONAKTIEBOLAGET L M ERICSSON (publ), Stockholm (SE)

(21) Appl. No.: 13/822,712

(22) PCT Filed: Sep. 14, 2010
(86) PCT No.: PCT/SE2010/050979

§ 371 Date: Mar. 13, 2013

(51) Int. Cl. G06Q 30/02

(52) U.S. Cl. CPC G06Q 30/0204
USPC 705/7.33

(57) ABSTRACT

A method and arrangement in a segmentation manager (200, 600) for forming segments of customers in a communications network for use when offering services to customers jointly in those segments. In the segmentation manager, data relating to the customers' service usage and websites browsed by the customers is collected (500) and subject domains associated to the browsed websites are identified (502). A browsing behaviour of each customer is also determined (504) based on their browsed websites and associated subject domains, and domain interests of each customer are determined (506) based on their browsing behaviour. At least one customer segment is then assigned (508) to each customer based on his/her service usage and domain interests.

### TECHNICAL FIELD

The invention relates generally to a method and arrangement for identifying segments of customers in a telecommunications network which can be used to support targeted marketing and provide relevant service offerings.

### BACKGROUND

In the field of telecommunication, solutions have been devised for identifying and offering services that are particularly relevant and attractive to different service consumers according to their interests and needs in different situations, also referred to as targeted marketing. It is therefore of great interest for service providers to understand their customers' behavior when consuming services, in order to achieve great efficiency in their marketing activities and service offerings. Thereby, the customers will also be better served by receiving more relevant and interesting service offerings which could increase their general responsiveness to such offerings.

There are also solutions for analyzing users in a telecommunication network and identifying segments of users, also referred to as “clusters”, having common characteristics in some sense, such that service offerings and marketing activities can be targeted to users in a specific segment collectively, i.e. jointly. This analysis work can be executed based on traffic data generated in communication networks. In this description, service users in a telecommunication network will be generally called “customers” and it is assumed that they use terminals provided with viewing screens.

Traffic data is generated by different communication nodes in the network and is stored as Call Detail Records (CDR) in a Charging data Reporting System (CRS), mainly to determine accurate charging of customers for executed calls and sessions. Traffic data can also be obtained by means of various traffic analyzing devices, such as Deep Packet Inspection (DPI) units and other traffic detecting devices, which can be installed at various network nodes.

The traffic data may refer to voice calls, SMS (Short Message Service), MMS (Multimedia Message Service), downloadings, e-mails, web games, etc., in this description collectively referred to as “sessions”. The traffic data includes information on the sessions, typically related to the type of service, duration, time of day and location. This type of information can thus be used to analyze the customers' behavioral characteristics in terms of service usage, a process also referred to as “data mining”. For example, Machine Learning Algorithms (MLA:s) and tools can be used for processing the traffic data.

A Data Mining Engine (DME) may further be employed that collects traffic data and extracts information therefrom using various data mining and machine learning algorithms. FIG. 1 illustrates an example of how data mining can be employed for a communication network, according to the prior art. A DME 100 typically uses various MLA:s 100a for processing traffic data TD provided from a data source 102, and further to identify customers segments or clusters. The data source 102 collects CDR information and DPI information from the network which is then provided as traffic data TD to the DME 100. After processing the traffic data, the DME 100 provides the resulting segment information as output data to various service providers 104 to enable adapted services and targeted marketing activities.

Another way of gaining knowledge of customer interests and preferences is to analyze downloaded documents, e.g. to identify the topic of a document being presumably of interest to the customer. This information can be derived from web usage data stored in the network, e.g. in the nodes GGSN (Gateway GPRS (General Packet Radio Service) Support Node) and SGSN (Serving GPRS Support Node) of a mobile network. Further, a procedure known as “collaborative filtering” can be used to obtain explicit ratings of products and services to provide recommendations to potential purchasers of those products and services. The known analysis method called “Latent Dirichlet Allocation” (LDA) can be used for document modeling and collaborative filtering. Communities of users forming social networks can also be identified based on their communications with each other, which can be jointly targeted with service offers. Customers having a certain Class of Service (CoS) may further be segmented, i.e. having equal level of service priority in a particular type of traffic.

However, the methods above may still not be sufficiently effective in finding the right customers willing to purchase a particular service, especially when the total amount of users in the network is huge. Of course, to ensure that no potential customers are missed in a marketing activity, a very large segment of customers can be addressed, or even all of them. On the other hand, this would require a lot of resources and efforts for achieving relatively low efficiency and pay-back from the marketing activity. Unnecessary and uninteresting advertising can also be rather disturbing for the customers resulting in a general negative attitude to such marketing activities.

### SUMMARY

It is an object of the invention to address at least some of the problems and issues outlined above. It is also an object to provide a mechanism for defining customer segments that are as apt as possible for offering services collectively to customers in the individual segments. It is possible to achieve these objects and others by using a method and an arrangement as defined in the attached independent claims.

According to one aspect, a method is provided for forming segments of customers in a communications network for use when offering services to customers jointly in the segments. In this method, data relating to the customers' service usage and websites browsed by the customers is collected and subject domains associated to the browsed websites are identified. A browsing behavior of each customer is determined based on their browsed websites and associated subject domains, and domain interests of each customer are determined based on the browsing behavior. At least one customer segment is then assigned to each customer based on his/her service usage and domain interests.

According to another aspect, an arrangement is provided in a segmentation manager that is configured to form segments of customers in a communications network to be used for offering services to customers jointly in the segments. According to this arrangement, a data collector is adapted to collect information on the customers' service usage and information on websites browsed by the customers. A browsing analyzer is adapted to identify subject domains associated to the browsed websites, determine a browsing behavior of each customer based on their browsed websites and associated subject domains, and to determine domain interests of each customer based on the browsing behavior. Further, a segmentation module is adapted to assign a customer segment to each customer based on his/her service usage and domain interests.

The above method and arrangement may be configured and implemented according to different embodiments. In one embodiment, the collected data relating to the customers' service usage is analyzed for determining any of: type of service, number of sessions, number of distinct contacts, session duration, spending, time of day, week or season, and location. The collected data can be obtained from Call Detail Records CDRs and/or Deep Packet Inspection DPI. The data relating to browsed websites may include a URL and a description for each website.

In other possible embodiments, the subject domains are identified for the websites based on the presence of keywords in the websites which have been predefined for the subject domains. Identifying subject domains for the websites may include computing probabilities for the presence of the keywords in the subject domains and probabilities for the subject domains to contain those keywords. The subject domains may be identified for the websites by using the method “Latent Dirichlet Allocation”, LDA. Determining domain interests of each customer may include computing probabilities for the subject domains being associated to websites browsed by the customer.

In further embodiments, assigning at least one customer segment to each customer includes determining a correlation between his/her service usage and domain interests and assigning the customer segment(s) based on the correlation. The customer segment(s) can be selected from an optimal number of customer segments which is determined by applying a K-means clustering algorithm on the collected information where a mean squared error is plotted against different numbers (K) of customer segments.

Further possible features and benefits of this solution will become apparent from the detailed description below.

### BRIEF DESCRIPTION OF DRAWINGS

The invention will now be described in more detail by means of exemplary embodiments and with reference to the accompanying drawings, in which:

FIG. 1 is a block diagram illustrating a conventional procedure for data mining, according to the prior art.

FIG. 2 is a block diagram illustrating a schematic processing flow in a segmentation manager for creating customer segments, according to some example embodiments.

FIG. 3 presents an illustrative example of a predefined subject domain scheme, according to another possible embodiment.

FIG. 4 is a flow chart illustrating how different parameters of FIG. 2 can be computed.

FIG. 5 is a flow chart with actions performed by a segmentation manager for creating customer segments, according to further example embodiments.

FIG. 6 is a block diagram illustrating in more detail an arrangement in a segmentation manager, according to further example embodiments.

### DETAILED DESCRIPTION

Briefly described, the invention provides an automated and effective mechanism for dividing telecommunication customers into segments that can be used when offering services to the customers jointly in each segment and generally for targeted marketing activities. By determining the customers' interests in different subject domains based on their browsing behavior, and assigning customer segments to the customers based on both their service usage and domain interests, a very accurate grouping and segmentation of customers is achieved in terms of susceptibility and openness of using services selected to be specifically attractive to the different customer segments. For customers that subscribe to services in a telecommunication network, the customer loyalty to the network operator can be cemented and reinforced by providing relevant service offerings that can be specifically adapted to respective customer segments in terms of detected interests and service usage.

In this solution, briefly described, the interests of a particular customer can be measured and quantified by computing probabilities for certain predefined subject domains being associated to websites browsed by the customer. Thereby, it can be determined basically how interesting these subject domains are to that customer. The subject domains can be identified as being associated to the browsed websites based on the presence of certain keywords in the websites which have been predefined for the subject domains. In this description, the term “website” is used to represent one or more downloadable web items such as web pages and documents that the customers can browse and view on their terminal screens. Further, the term “service usage” refers to services in a communication network.

By determining a correlation between the computed domain interest probabilities of each customer and their registered usage of communication services, different customer segments can be assigned to the customers based on this correlation, such that each segment comprises customers with analogous characteristics with respect to domain interests and service usage. It is thus deemed likely that the customers classified within such a segment have common needs and requirements for new services and can therefore be expected to be responsive to the same service offerings and disposed to accept and consume the same.

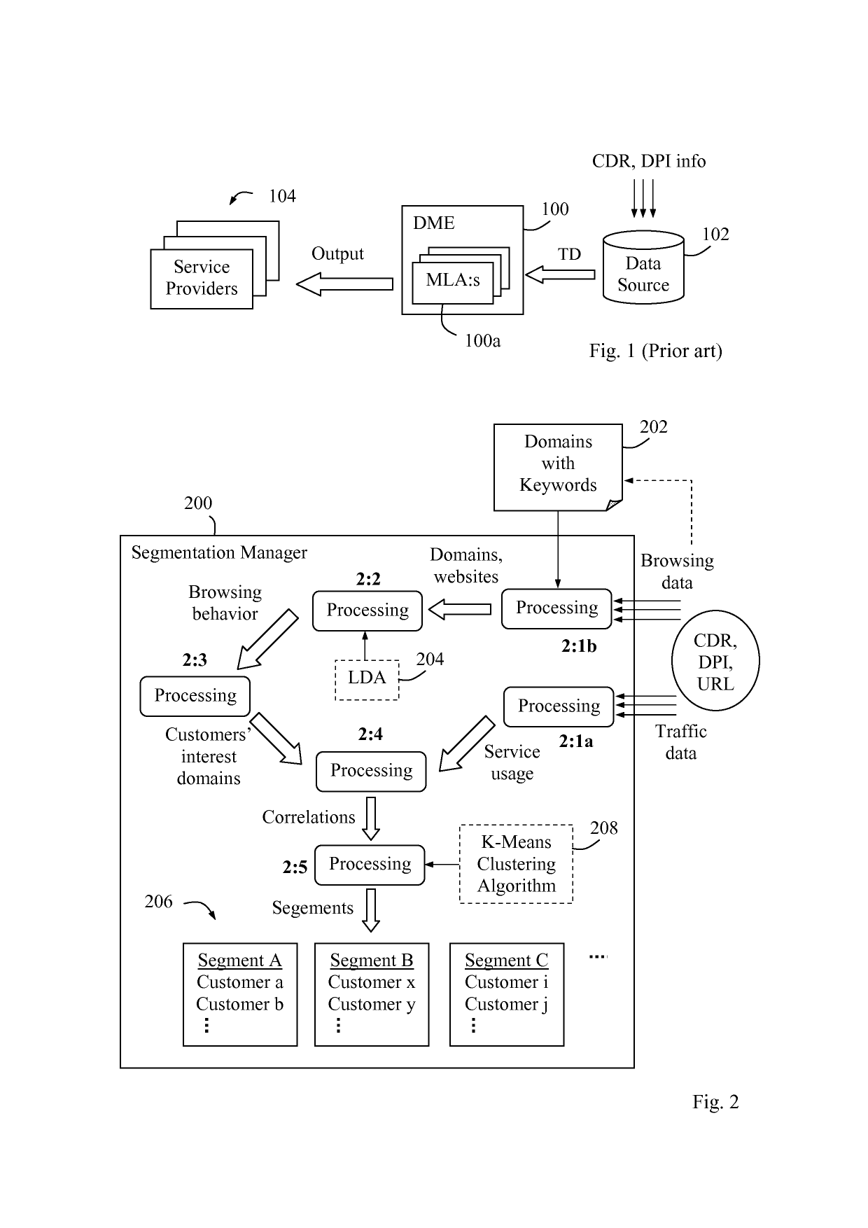

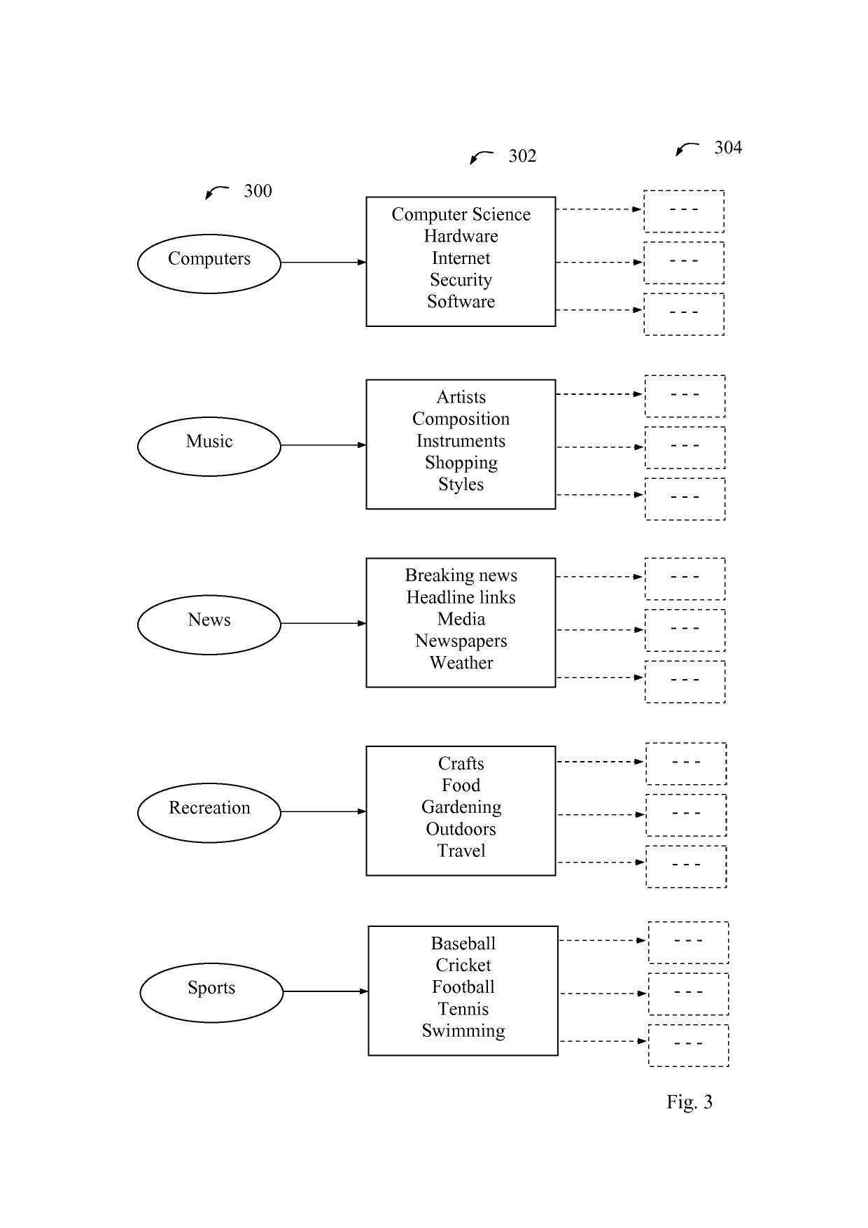

The invention can be realized by implementing various processing and computing functions in an entity or server which will be referred to in the following as a “segmentation manager”, although any other suitable name could be applied such as, e.g., a unit/manager/module/entity for “clustering” or “classification” of customers, and so forth. An example procedure of determining customer segments will now be described with reference to FIG. 2, illustrating schematically an overall process executed by the shown segmentation manager 200.

The input data needed and used by the segmentation manager 200 to determine effective and useful customer segments includes both traffic data reflecting the service usage of the customers and browsing data reflecting the browsing activities of the customers in terms of visited/browsed websites. As described above, data of executed service sessions and browsing activities can be extracted from CDR information and/or DPI information, which can be separated into traffic data and browsing data. Typically, the amount of available input data will be quite large, e.g. for applications in a system for telecommunication services.

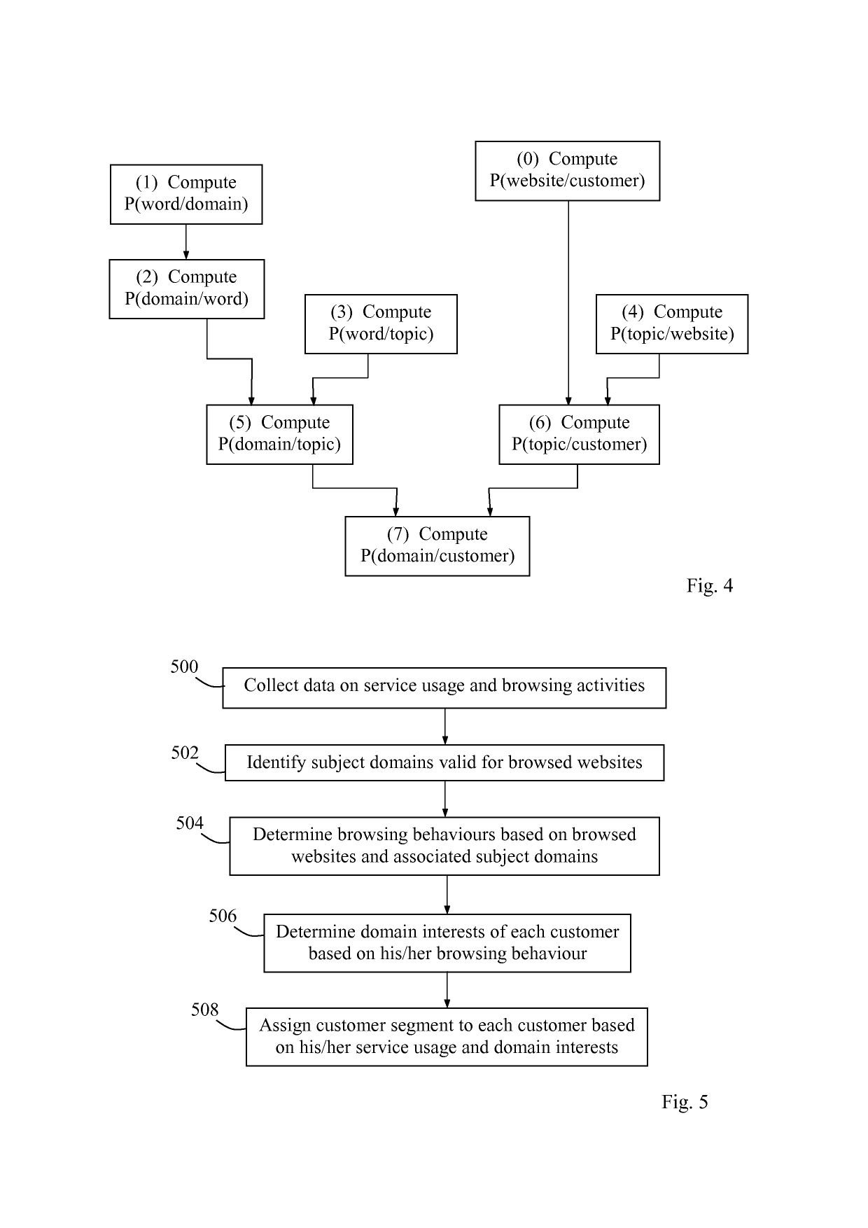

In more detail, the browsing data thus relates to websites browsed by the individual customers and may comprise a URL and a description for each website, while the traffic data relates to various service sessions executed by the customers, e.g. involving voice call, SMS, MMS, downloading, e-mail, web game, etc. This invention is not limited to any particular types of browsing data, traffic data and service usage. Various exemplary parameters can be computed in this procedure in the form of statistical distributions or probabilities based on the incoming data to arrive at a useful segmentation of the customers, which will be outlined below. In this procedure description, reference will also be made to FIG. 4 at the same time which provides a schematic overview of how the different parameters can be computed from one another according to this example. It is assumed that suitable tools and methods for such statistic analysis can be used for computing the parameters as follows.

An action 2:1a illustrates that incoming traffic data resulting from service usage is processed to basically determine the customers' service usage on an individual basis. The traffic data thus relates to each customers' executed service sessions and can be analyzed for determining different parameters reflecting service usage, e.g., any of: type of service, number of sessions, number of distinct contacts, session duration, spending, time of day, week or season and location. The service usage can be expressed in terms of quantity as different attributes, e.g., the number of a particular type of session executed per week, the average total session duration per week, the average duration per session, the average spending for sessions per week, and so forth. The invention is not limited to any particular parameters or attributes reflecting the service usage of customers.

Another action 2:1b in FIG. 2 illustrates that incoming browsing data is processed to basically identify which subject domains can be associated to the browsed websites. In more detail, a set of subject domains and associated keywords 202 for each domain have been predefined in advance, e.g. in a manual operation, which are used as input as well to action 2.1b such that the keywords of each predefined subject domain are matched with the content and/or description of each browsed website in a wholly automated manner. If a sufficient match is found for a browsed website, i.e. when one or more keywords of a particular subject domain are found in that website, the website is identified as belonging to that subject domain. If any new word of significance is found which has not been defined as a keyword for any subject domain, that new word can be added in this process as a keyword for a particular subject domain, depending on its relevance to that subject domain. Adding such new keywords is a manual operation.

As indicated by a dashed arrow, the manual operation of predefining the domains and associated keywords 202 may be based on the browsing activities indicated by the incoming browsing data, that is, to identify the websites of interest to the customers. The descriptions of the browsed websites may be obtained from a so-called meta engine or the like.

Depending on the field of application, the subject domains can be defined in any suitable manner, and one possible scheme of predefined subject domains is illustrated in FIG. 3. The subject domains 300 have thus been predefined in this example as five main domains: 1) Computers, 2) Music, 3) News, 4) Recreation, and 5) Sports. The subject domains 300 could also be referred to as “concepts”, “categories”, “areas/fields of interest”, or similar. Further, each domain may in turn be divided into plural sub-domains 302, as shown by further examples in FIG. 3. For example, the subject domain Music comprises the sub-domains of a) Artists, b) Composition, c) Instruments, d) Shopping, and e) Styles. Each sub-domain may in turn be divided into further sub-domains 304, as schematically indicated by dashed lines in the figure. This invention is however not limited to any particular schemes or definitions for subject domains, sub-domains or number of sub-levels.

In this automated process, the frequency of different websites accessed by each customer is deduced from the incoming data, which may be indicated as “P(website/customer)” or (0) for short. Further, the subject domains may be identified for the websites by computing probabilities for the presence of respective keywords of the subject domains, denoted as “P(word/domain)” or (1) for short, from which probabilities for the subject domains to contain the keywords, denoted as “P(domain/word)” or (2) for short, can also be computed e.g. using “Bayes Theorem”. The outcome of action 2:1b thus basically reflects how relevant or significant the different predefined subject domains, and sub-domains if used, are in the browsed websites, based on the occurrence of associated keywords, and reflects also which websites the customers have accessed.

In a next action 2:2, this information is used for determining a browsing behavior of each customer based on the above frequency of browsed websites by respective customers and their associated subject domains. In this action, the accessed websites are analyzed and a set of “topics” may be deduced from the description of each accessed website or document using a suitable mechanism for semantic analysis, preferably the above-mentioned LDA analysis method 204 for document modeling. In this analysis, the distribution of different keywords across the topics is computed as the probability “P(word/topic)” or (3) for short. As each website or document can be seen as a mixture of various topics, the distribution of each topic across the websites can also be computed as a probability “P(topic/website)” or (4) for short.

Next in action 2:2, the distribution of each predefined domain or sub-domain across the above topics may now be computed as a probability “P(domain/topic)” or (5) for short, using (3) and (2) above as follows:

$$P ( domain \text{/} topic ) = {\sum }_{Words} P ( word \text{/} topic ) * P ( domain \text{/} word ) \qquad ( 5 )$$

The distribution of each topic across the customers may now also be computed as a probability “P(topic/customer)” or (6) for short, using (0) and (4) above as follows:

P(topic/customer)=ΣP(website/customer)*P(topic/website) (6)

Thus reflecting the browsing behavior of each customer as the outcome of action 2:2.

Next, the distribution of deduced domain interests is computed for each customer based on their browsing behavior, in a further action 2:3. In this action, the distribution of domain interests can be computed for each domain or sub-domain to be valid for websites accessed by each customer. Thus, the distribution of each predefined domain or sub-domain across the customers can now be computed as a probability “P(domain/customer)” or (7) for short, using (5) and (6) above as follows:

$$P ( domain \text{/} customer ) = {\sum }_{Topics} P ( domain \text{/} topic ) * P ( t opic \text{/} customer ) \qquad ( 7 )$$

Thus reflecting the domains of interest for each customer.

In a further action 2:4, the above computed domain interests of each customer from action 2:3 are correlated with the customer's service usage from action 2:1a. The correlations of service usage and domain probability determined for the customers are then used as input to a clustering algorithm which is executed in a next action 2:5, to obtain a relevant and useful division of the customers into more or less homogenous customer segments 206 with respect to service usage and domain interests, i.e. each customer will be assigned and belong to at least one customer segment.

In this action, at least one customer segment can thus be assigned to each customer by determining the correlation between his/her service usage and domain interests and the customer segment(s) are assigned based on that correlation. In FIG. 2, some example segments have been formed including segment A with customers a, b, . . . , segment B with customers x, y, . . . , and segment C with customers i, j, . . . , and so forth.

In more detail, the customer segment(s) to be used can be selected from an optimal number of customer segments determined by applying a K-means clustering algorithm 208 on the collected information. In this clustering algorithm, a mean squared error is plotted against different candidate numbers K of K customer segments. The K value at which the error is deemed to stabilize is selected as the optimal K value.

The segments 206 formed can then be analyzed for their domain interests in association with their service usage behavior, to provide a target set of consumers e.g. having the required usage rates and specific domain interests as subjects for marketing activities and service offerings. These consumers may be targeted based on an optimal sub domain of their interest which relates with a particular new service offer. The process of utilizing the customer segments for marketing activities and service offerings lies however outside the scope of this invention.

It should be noted that some actions in the procedure described above for FIG. 2 may be performed simultaneously. For example, actions 2:1b-2:3 may be performed basically at the same time as action 1:1a and independent thereof.

A procedure will now be described, with reference to the flow chart in FIG. 5, of forming segments of customers in a communications network for use when offering services to customers jointly in those segments. This procedure may thus basically be realized by means of the segmentation manager 200 of FIG. 2. In a first action 500, the segmentation manager collects data relating to the customers' service usage and websites browsed by the customers, which can be made basically as described above for actions 2:1a and 2:1b.

In a next action 502, the segmentation manager identifies subject domains associated to the browsed websites, which can be made basically as described above for action 2:1b. In a further action 504, the segmentation manager determines a browsing behavior of each customer based on their browsed websites and associated subject domains, which can be made basically as described above for action 2:2. The segmentation manager then also determines domain interests of each customer based on their browsing behavior in a following action 506, which can be made basically as described above for action 2:3.

In a final shown action 508, the segmentation manager assigns at least one customer segment to each customer based on his/her service usage and domain interests, which can be made basically as described above for actions 2:4 and 2:5.

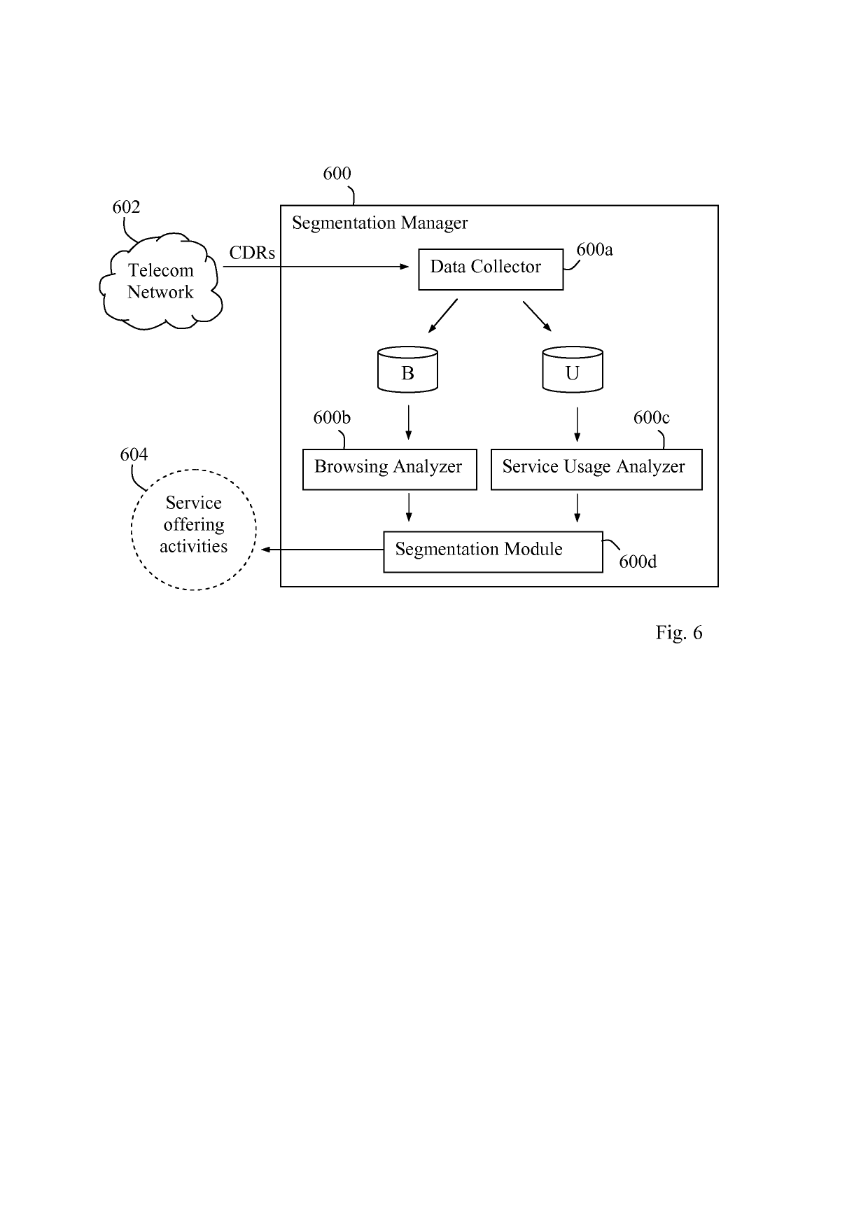

With reference to the block diagram in FIG. 6, an arrangement in a segmentation manager 600, configured to form segments of customers in a communications network to be used for offering services to customers jointly in those segments, will now be described. This arrangement may be implemented as an application in the segmentation manager. The segmentation manager 600 can be configured to basically operate according to any of the examples described above for FIGS. 2-5, whenever appropriate.

According to this arrangement, the segmentation manager 600 comprises a data collector 600a adapted to collect information on the customers' service usage “U” and information on websites browsed by the customers “B”. The segmentation manager 600 further comprises a browsing analyzer 600b adapted to identify subject domains associated to the browsed websites and determine a browsing behavior of each customer based on their browsed websites and associated subject domains. The browsing analyzer 600b is also adapted to determine domain interests of each customer based on the determined browsing behavior.

The segmentation manager 600 further comprises a segmentation module 600d adapted to assign a customer segment to each customer based on his/her service usage and domain interests. The outcome from module 600d can then be used for various suitable service offering activities, schematically denoted 604, the details of which are somewhat outside the scope of this solution. The segmentation manager 600 may also comprise a service usage analyzer 600c adapted to analyze the collected data relating to the customers' service usage for determining any of: type of service, number of sessions, number of distinct contacts, session duration, spending, time of day, week or season, and location.

The different modules in the enrolment server 600 may be configured and adapted to provide further optional features and embodiments. In one example embodiment, the data collector 600a is further adapted to obtain the collected data from CDR and/or DPI information. As in the examples above, the data relating to browsed websites may comprise a URL and a description for each website.

In another example embodiment, the browsing analyzer 600b can be further adapted to identify the subject domains for the websites based on the presence of keywords in the websites which have been predefined for the subject domains. In that case, the browsing analyzer 600b may identify these subject domains by computing probabilities for the presence of the keywords in the subject domains and probabilities for the subject domains to contain the keywords.

Further, the browsing analyzer 600b may be further adapted to identify the subject domains for the websites by using the above-mentioned LDA method. The browsing analyzer 600b may also be adapted to determine the domain interests of each customer by computing probabilities for the subject domains being associated to websites browsed by the customer.

In further possible embodiments, the segmentation module 600d is further adapted to assign at least one customer segment to each customer by determining a correlation between his/her service usage and domain interests and assigning the customer segment(s) based on the correlation. The segmentation module 600d may also be adapted to select the customer segment(s) from an optimal number of customer segments determined by applying a K-means clustering algorithm on the collected information where a mean squared error is plotted against different numbers (K) of customer segments.

It should be noted that FIG. 6 merely illustrates various functional modules or units in the segmentation manager 600 in a logical sense, although the skilled person is free to implement these functions in practice using suitable software and hardware means. Thus, the invention is generally not limited to the shown structures of the segmentation manager 600, while its functional modules 600a-d may be configured to operate according to the features described for FIGS. 2-5 above, where appropriate.

The functional modules 600a-d described above can be implemented in the segmentation manager 600 as program modules of a computer program comprising code means which when run by a processor in the manager 600 causes the manager 600 to perform the above-described functions and actions. The processor may be a single CPU (Central processing unit), or could comprise two or more processing units. For example, the processor may include general purpose microprocessors, instruction set processors and/or related chips sets and/or special purpose microprocessors such as ASICs (Application Specific Integrated Circuit). The processor may also comprise board memory for caching purposes.

The computer program may be carried by a computer program product in the segmentation manager 600 connected to the processor. The computer program product comprises a computer readable medium on which the computer program is stored. For example, the computer program product may be a flash memory, a RAM (Random-access memory), a ROM (Read-Only Memory) or an EEPROM (Electrically Erasable Programmable ROM), and the program modules could in alternative embodiments be distributed on different computer program products in the form of memories within the segmentation manager 600.

An advantage of this solution is that the service providers' resources for marketing activities and for providing service offerings to their customers can be utilized in a much more effective manner by addressing only customers deemed responsive to the offered services, i.e. using the above customer segmentation. As a result, the service providers can now focus on only a limited set of customers rather than an entire customer base, thereby saving costs for distributing the service offerings, among other things. Only these customers can be targeted with specific customized services pertaining to their domain interests and service usage and spending patterns.

Moreover, such relevant and customized service offerings are likely to attract an interest to the customers, since they have been approached based on their specific service usage, interests and requirements, rather than being unnecessarily disturbed for all campaigns. The attitude to service offerings can thereby be enhanced and the customers' loyalty to the service provider can be cemented and reinforced.

While the invention has been described with reference to specific exemplary embodiments, the description is generally only intended to illustrate the inventive concept and should not be taken as limiting the scope of the invention. The invention is defined by the appended claims.

1. A method of forming segments of customers in a communications network for use when offering services to customers jointly in said segments, the method comprising:
collecting data relating to the customers' service usage and websites browsed by the customers,
identifying subject domains associated to the browsed websites,
determining a browsing behaviour of each customer based on their browsed websites and associated subject domains,
determining domain interests of each customer based on said browsing behaviour, and
assigning at least one customer segment to each customer based on his/her service usage and domain interests.

2. A method according to claim 1, wherein the collected data relating to the customers' service usage is analyzed for determining any of: type of service, number of sessions, number of distinct contacts, session duration, spending, time of day, week or season, and location.

3. A method according to claim 1, wherein the collected data is obtained from Call Detail Records (CDRs) and/or Deep Packet Inspection (DPI).

4. A method according to claim 1, wherein said data relating to browsed websites comprises a URL and a description for each website.

5. A method according to claim 1, wherein the subject domains are identified for said websites based on the presence of keywords in the websites which have been predefined for the subject domains.

6. A method according to claim 5, wherein identifying subject domains for said websites includes computing probabilities for the presence of said keywords in the subject domains and probabilities for the subject domains to contain said keywords.

7. A method according to claim 1, wherein the subject domains are identified for said websites by using the method “Latent Dirichlet Allocation” (LDA).

8. A method according to claim 1, wherein determining domain interests of each customer includes computing probabilities for the subject domains being associated to websites browsed by the customer.

9. A method according to claim 1, wherein assigning at least one customer segment to each customer includes determining a correlation between his/her service usage and domain interests and assigning the customer segment(s) based on said correlation.

10. A method according to claim 1, wherein said customer segment(s) is/are selected from an optimal number of customer segments determined by applying a K-means clustering algorithm on the collected information where a mean squared error is plotted against different numbers (K) of customer segments.

11. An arrangement in a segmentation manager configured to form segments of customers in a communications network to be used for offering services to customers jointly in said segments, comprising:
a data collector adapted to collect information on the customers' service usage (U) and information on websites browsed by the customers (B),
a browsing analyzer adapted to identify subject domains associated to the browsed websites, determine a browsing behaviour of each customer based on their browsed websites and associated subject domains, and to determine domain interests of each customer based on said browsing behaviour, and
a segmentation module adapted to assign a customer segment to each customer based on his/her service usage and domain interests.

12. An arrangement according to claim 11, further comprising a service usage analyzer adapted to analyze the collected data relating to the customers' service usage for determining any of: type of service, number of sessions, number of distinct contacts, session duration, spending, time of day, week or season, and location.

13. An arrangement according to claim 11, wherein the data collector is further adapted to obtain the collected data from Call Detail Records (CDRs) and/or Deep Packet Inspection (DPI).

14. An arrangement according to claim 11, wherein said data relating to browsed websites comprises a URL and a description for each website.

15. An arrangement according to claim 11, wherein the browsing analyzer is further adapted to identify the subject domains for said websites based on the presence of keywords in the websites which have been predefined for the subject domains.

16. An arrangement according to claim 15, wherein the browsing analyzer is further adapted to identify subject domains for said websites by computing probabilities for the presence of said keywords in the subject domains and probabilities for the subject domains to contain said keywords.

17. An arrangement according to claim 11, wherein the browsing analyzer is further adapted to identify the subject domains for said websites by using the method “Latent Dirichlet Allocation” (LDA).

18. An arrangement according to claim 11, wherein the browsing analyzer is further adapted to determine domain interests of each customer by computing probabilities for the subject domains being associated to websites browsed by the customer.

19. An arrangement according to claim 11, wherein the segmentation module is further adapted to assign at least one customer segment to each customer by determining a correlation between his/her service usage and domain interests and assigning the customer segment(s) based on said correlation.

20. An arrangement according to claim 11, wherein the segmentation module is further adapted to select said customer segment(s) from an optimal number of customer segments determined by applying a K-means clustering algorithm on the collected information where a mean squared error is plotted against different numbers (K) of customer segments.
